(19) United States
(12) Patent Application Publication
(10) Pub. No.: US 2022/0258468 A1
(43) Pub. Date: Aug. 18, 2022

(54) LIQUID EJECTION HEAD AND LIQUID EJECTION DEVICE

(71) Applicant: TOSHIBA TEC KABUSHIKI KAISHA, Tokyo (JP)

(72) Inventor: Masashi SHIMOSATO, Mishima Shizuoka (JP)

(21) Appl. No.: 17/535,109

(22) Filed: Nov. 24, 2021

(30) Foreign Application Priority Data
Feb. 18, 2021 (JP) 2021-024522

(51) Int. Cl. B41J 2/14

(52) U.S. Cl. CPC B41J 2/14233

(57) ABSTRACT

According to one embodiment, a liquid ejection head includes an actuator and a diaphragm. The actuator has plate-shaped piezoelectric members stacked one on the other in a stacking direction. The plate-shaped piezoelectric members each comprise a lead-free piezoelectric material. The diaphragm is adjacent to the actuator. The diaphragm is configured to vibrate in its thickness direction based on vibrations of the plate-shaped piezoelectric members in the stacking direction.

### CROSS-REFERENCE TO RELATED APPLICATION

This application is based upon and claims the benefit of priority from Japanese Patent Application No. 2021-024522, filed Feb. 18, 2021, the entire contents of which are incorporated herein by reference.

### FIELD

Embodiments described herein relate generally to a liquid ejection head and a liquid ejection device.

### BACKGROUND

Inkjet heads using lead-containing piezoelectric material, such as lead zirconate titanate (PZT) have been commercialized. Unfortunately, lead-containing piezoelectric materials such as PZT may be harmful to the environment. Therefore, inkjet heads using a lead-free piezoelectric material are desirable. However, it has been difficult to put lead-free piezoelectric materials into practical use in inkjet heads because the characteristics of such materials, like the Curie temperature, of such possible lead-free materials such as barium titanate-based material is too low, or the piezoelectric constant (piezoelectric modulus) of other possible materials such as potassium sodium niobate-based materials is too small. In addition, lead-free piezoelectric materials tend to have a high cost.

### BRIEF DESCRIPTION OF THE DRAWINGS

FIG. 1 is a perspective view of a part of an inkjet head according to a first embodiment.

FIG. 2 is a cross-sectional view illustrating a schematic configuration of an inkjet head.

FIG. 3 is a perspective view illustrating stacked piezoelectric members of an inkjet head.

FIG. 4 is a side view illustrating the stacked piezoelectric members of an inkjet head.

FIG. 5 is a table with characteristics of materials of stacked piezoelectric members.

FIG. 6 is a table illustrating characteristics of materials of stacked piezoelectric members.

FIG. 7 depicts a schematic configuration of an inkjet recording device according to a first embodiment.

### DETAILED DESCRIPTION

In general, according to one embodiment, a liquid ejection head includes an actuator and a diaphragm. The actuator comprises plate-shaped piezoelectric members stacked one on the other in a stacking direction. The plate-shaped piezoelectric members each comprises a lead-free piezoelectric material. The diaphragm is adjacent to the actuator. The diaphragm is configured to vibrate in its thickness direction in response to vibrations of the plate-shaped piezoelectric members in the stacking direction.

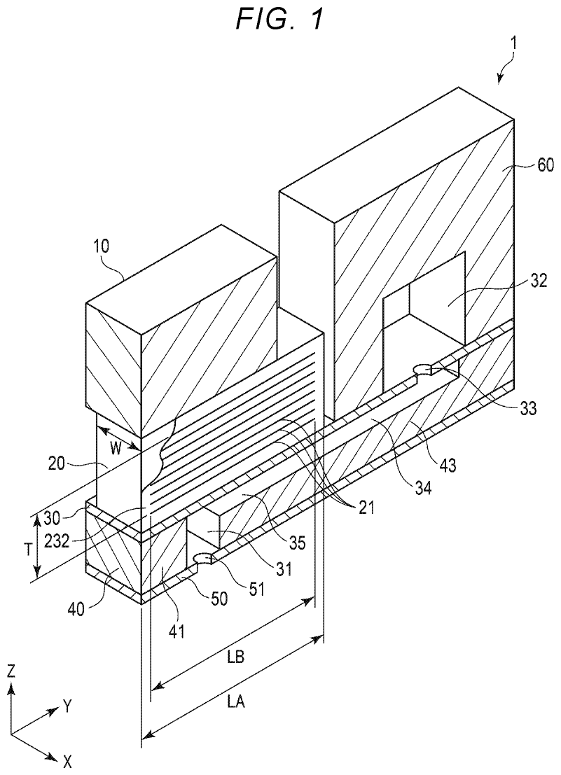

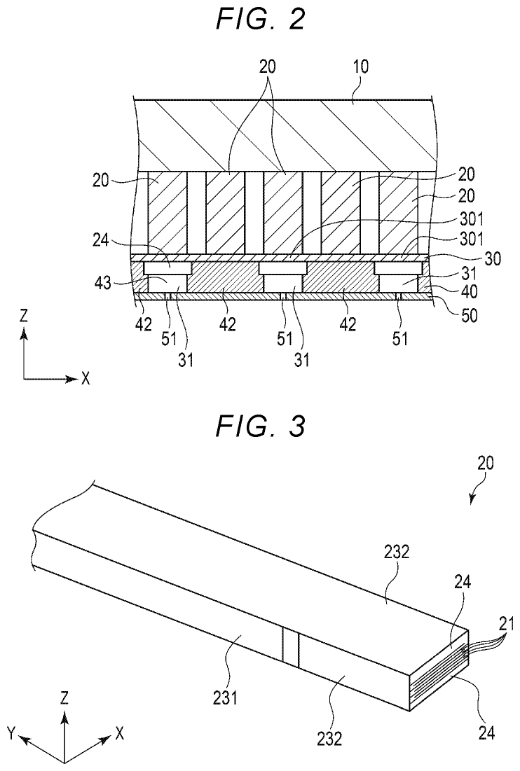

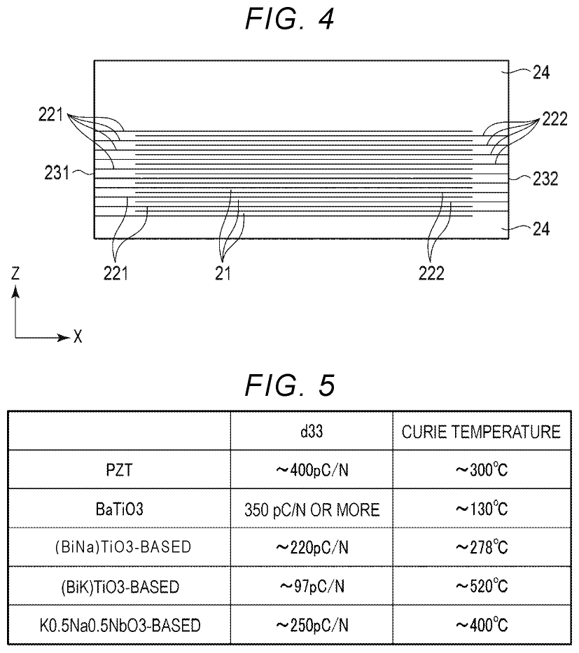

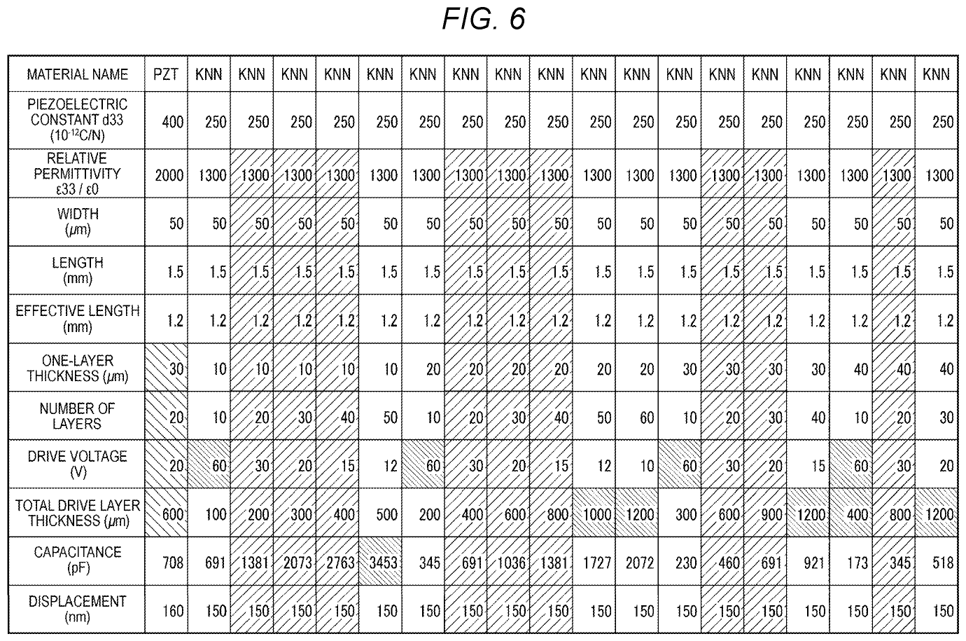

Hereinafter, example embodiments of a liquid ejection head and a liquid ejection device will be described with reference to the accompanying drawings. In one example, an inkjet head 1 (which is one example of a liquid ejection head) and an inkjet recording device 100 (which is one example of a liquid ejection device) will be described with reference to FIGS. 1 to 7. FIG. 1 is a perspective view illustrating a schematic configuration of the inkjet head 1. FIG. 2 is a cross-sectional view of inkjet head 1. FIG. 3 is a perspective view illustrating stacked piezoelectric members of an inkjet head. FIG. 4 is a side view of the same. FIGS. 5 and 6 are tables of characteristics of certain piezoelectric materials. For purposes of description, the illustrated aspects in each drawing may be depicted as enlarged or reduced, or, in some instances, aspects may be omitted from one or more drawings.

The inkjet head 1 includes a base 10, at least one piezoelectric element 20, a diaphragm 30, a manifold 40, a nozzle plate 50 (having a plurality of nozzles 51 therein), and a frame 60.

The piezoelectric element 20 functions as an actuator. The piezoelectric element 20 comprises a plurality of piezoelectric members 21. As depicted in FIG. 1, these piezoelectric members 21 are stacked on each other along a Z direction. Internal electrodes 221 and internal electrodes 222 (internal electrode pairs) are formed on each piezoelectric member 21. An external electrode 231 and an external electrode 232 are formed on side surfaces of the piezoelectric element 20. Dummy layers 24 are stacked on the outermost ones of the stacked piezoelectric elements 21.

The piezoelectric element 20 is positioned at an end of the base 10 in the Y direction and is joined (affixed) to the base 10.

Each piezoelectric member 21 is a lead-free piezoelectric material formed in a thin plate shape. The piezoelectric member 21 may be a lead-free piezoelectric ceramic comprising potassium sodium niobate as a main component. The piezoelectric members 21 are stacked one on the other along a first thickness direction (Z direction in FIG. 1) and are bonded to each other layer-by-layer with an adhesive layer.

The internal electrodes 221 and 222 (FIG. 4) are conductive films made of a conductive material that can be calcined (strongly heated), such as silver-palladium. The internal electrodes 221 and 222 are separated from each other. For example, each internal electrode 221 extends in the X direction from one end of the piezoelectric member 21 but does not reach the other end in the X direction. Each internal electrode 222 is formed extending in the X direction from the opposite end of the piezoelectric member 21 but does not reach the other end in the X direction. The internal electrodes 221 are connected to an external electrode 231 formed on the side surface of the piezoelectric element 20. The internal electrodes 222 are connected to an external electrode 232.

The external electrodes 231 and 232 are formed on the side surfaces of the piezoelectric element 20. Each external electrode 231 connects to multiple internal electrodes 221. Likewise, each external electrode 232 connects to multiple internal electrodes 222. The external electrodes 231 and 232 are formed of a metal such as Ni, Cr, Au, or the like by a plating method or a sputtering method. The external electrodes 231 and 232, which are separate electrodes that can be disposed in different regions on the same side surface of the piezoelectric element 20. Alternatively, the external electrodes 231 and 232 may be disposed on different side surfaces. Ends of the internal electrodes 221 and 222 are connected to various wirings via external electrodes 231 and 232. These various wirings are connected to components such as a drive integrated circuit (IC).

Each dummy layer 24 is made of the same material as a piezoelectric member 21. The dummy layer 24 has an electrode on only one side and is thus not deform because an electric field is not applied to the dummy layer 24. That is, the dummy layer 24 does not function as a piezoelectric member even though formed of piezoelectric material, but rather serves as a base for fixing the piezoelectric element 20 to other components, or as a polishing margin for a polishing process used for providing dimensional accuracy for assembly.

The piezoelectric element 20 vibrates up and down (vertically) along the stacking direction (Z direction) of the piezoelectric members 21 when a voltage is applied to the internal electrodes 221 and 222 via the external electrodes 231 and 232. In this context, vertical vibration corresponds to “vibration in the thickness direction defined by the piezoelectric constant d33”.

As illustrated in FIG. 2, only half of the piezoelectric elements 20 are disposed so as to be positioned directly above one of the pressure chambers 31 (with the diaphragm 30 interposed therebetween). The other half of the piezoelectric elements 20 are disposed at positions facing one of the partition walls 42 (with the diaphragm 30 interposed therebetween). That is, only every other one of the piezoelectric elements 20 corresponds directly to a pressure chamber 31.

FIG. 5 is a table illustrating the characteristics of certain piezoelectric materials taken from Chapter 3 of “Lead-free Piezoelectric Ceramics Devices”, edited by Japan AEM Society, Yokendo). FIG. 5 lists the piezoelectric constants (d33) and Curie temperatures for PZT, barium titanate-based (BaTiO₃) material, bismuth sodium titanate-based ((BiNa)TiO₃) material, bismuth potassium titanate-based material ((BiK)TiO₃), and potassium sodium niobate-based (KNN) (K0.5Na0.5NbO₃). As listed, the piezoelectric constant d33 of PZT is about 400 pC/N, and the Curie temperature is about 300° C. The piezoelectric constant d33 of barium titanate-based material is 350 pC/N or more, and the Curie temperature is about 130° C. The piezoelectric constant d33 of (BiNa)TiO₃-based material is about 220 pC/N, and the Curie temperature is about 278° C. The piezoelectric constant d33 of (BiK)TiO₃-based material is about 97 pC/N, and the Curie temperature is about 520° C. The piezoelectric constant d33 of potassium sodium niobate-based material is about 250 pC/N, and the Curie temperature is about 400° C.

As illustrated in FIG. 5, the piezoelectric constant (d33) of the barium titanate-based material is larger than the piezoelectric constants of the other non-PZT materials. The Curie temperature of the barium titanate-based material is lower the Curie temperature of the other material. Therefore, the manufacturing process of barium titanate-based is somewhat restricted as is the operating temperature in comparison to the other materials. The piezoelectric constants of bismuth titanate-based materials ((BiK) TiO₃ and (BiNa) TiO₃) are smaller than the piezoelectric constant of the other materials. Therefore, with the bismuth titanate-based materials, in order to realize the same ejection performance as PZT, it is necessary to increase the drive voltage, and the ejection element becomes large. On the other hand, the potassium sodium niobate (KNN)-based material has a relative permittivity (ε33/ε0), which is about half the relative permittivity of PZT, and there is no substantial difference in power consumption. The Curie temperature of potassium sodium niobate (KNN)-based material is higher than the Curie temperature of the other materials other than bismuth potassium titanate-based material ((BiK)TiO₃).

FIG. 6 is a table illustrating a relationship between the specific configuration of the piezoelectric element 20 to the drive voltage and the displacement. FIG. 6 illustrates the relationship between the relative permittivity (ε33/ε0), piezoelectric constant (d33), width W, length LA, effective length LB, one-layer thickness (per layer thickness), total number of layers, drive voltage, total drive layer thickness T, capacitance, and displacement of the stacked and vertically vibrating PZT and potassium sodium niobate-based piezoelectric elements 20. The width W, length LA, effective length LB, and total drive layer thickness T are as illustrated in FIG. 1. The width W is the dimension of the piezoelectric element 20 in the X-direction. The length LA is the dimension of the piezoelectric element 20 in the Y direction. The effective length LB is the dimension of the region in the Y direction where the plurality of internal electrodes 221 and 222 and piezoelectric member 21 of the piezoelectric element 20 are stacked. The one-layer thickness is the one-layer dimension in the Z-direction of the piezoelectric member 21. The one-layer thickness includes therein the electrodes 221 and 222. The total drive layer thickness T is the product of one-layer thickness and the total number of stacked layers (number of layers).

FIG. 6 illustrates the capacitance and displacement amount calculated from the characteristic shape of the potassium sodium niobate-based piezoelectric material, and the combination with the same displacement as a reference PZT material for the same drive voltage.

For example, based on the stacked and vertically vibrating PZT elements having a one-layer thickness of about 30 μm, about 20 layers, d33 of about 400, and a relative permittivity (ε33/ε0) of about 2000 (which are common values often used for conventional inkjet heads), the dimensions and the number of layers providing the same displacement at the same drive voltage as a potassium sodium niobate-based piezoelectric element 20 were calculated. The potassium sodium niobate-based piezoelectric element 20 preferably has 50 or fewer stacked layers, a thickness of 10 μm to 40 μm, and the product of the thickness and the total number of stacked layers is less than 1000 μm. In general, width and length can be changed as appropriate for device design. If the product of the thickness and the total number of stacked layers is, for example, 1000 μm or more, the thickness may be too large, and the groove that divides each pressure chamber becomes very deep, which makes the manufacturing processing difficult. If both the thickness and the drive voltage are large (for example, drive voltage of 60 V or more), it may be necessary to change out the drive IC to a more capable device. When the capacitance is too large (for example, 3453 pF or more), the power consumption is high, and there are also restrictions on the thickness and the number of layers to be used in order to obtain the same displacement as PZT.

The diaphragm 30 is disposed on one side of the piezoelectric element 20 in the stacking direction. In the present example, the diaphragm 30 comprises a plurality of vibrating portions 301 that are each separately facing one of the pressure chambers 31. The vibrating portions 301 can be individually displaced by different piezoelectric elements 20. The plurality of vibrating portions 301 are each integral portions of the diaphragm 30. In other examples, a plurality of diaphragms 30 that are each individually displaceable may be adopted.

On one side, the diaphragm 30 is joined to ends of the piezoelectric element 20 The frame 60 is on the same side of the diaphragm 30 as the piezoelectric elements 20 but offset in the Y direction from the piezoelectric elements 20. The manifold 40 is on the other side of the diaphragm 30 from the manifold 40 and the piezoelectric elements 20. In a central portion of the inkjet head 1, the pressure chamber 31 for accommodating ink and a guide flow path 34 are formed between the diaphragm 30 and the manifold 40. A common chamber 32 for accommodating ink is formed between the diaphragm 30 and the frame 60. That is, one side of the diaphragm 30 faces the piezoelectric element(s) 20, and the opposite side faces the pressure chamber (s) 31, the partition wall portions 42, and the guide flow path 34.

Each pressure chamber 31 connects to a nozzle 51 formed in a nozzle plate 50. Pressure chambers 31 and the guide flow paths 34 are separated from each other by the partition wall portions 42 of the manifold 40.

The diaphragm 30 has an opening 33 that penetrates in the thickness direction and connects the pressure chamber 31 and the common chamber 32 via a guide flow path 34. The diaphragm 30 is between the common chamber 32 and the first pressure chamber(s) 31 in the Z direction. The common chamber 32 extends in the X direction and connects with the plurality of pressure chambers 31, which arranged along the X direction. The diaphragm 30 is deformed by the deformation of the piezoelectric element 20 so as to change the volume of the pressure chamber 31.

The manifold 40 is joined to one side of the diaphragm 30. The manifold 40 is between the nozzle plate 50 and the diaphragm 30. An ink flow path 35 extending from each of the plurality of pressure chambers 31 toward the opening 33 in the Y direction is formed. The manifold 40 includes a frame-shaped portion 41 joined to the outer edge portion of the diaphragm 30, a plurality of partition wall portions 42 (that separate the ink flow paths 35), and a guide wall 43 (that forms the guide flow path 34).

One side of the plurality of pressure chambers 31 is closed by the nozzle plate 50 (with the nozzle 51 therein) 51, and the other side is closed by the diaphragm 30. The pressure chambers 31 communicate with the common chamber 32 via the guide flow path 34 and the opening 33. Each pressure chamber 31 holds liquid supplied from the common chamber 32 via the guide flow path 34, and is deformed by the vibration of the diaphragm 30 so as to eject the liquid from the nozzle 51.

The nozzle plate 50 is a square or rectangular plate having a thickness of about 10 μm to 100 μm, which is made of a metal such as SUS/Ni (stainless steel/nickel) or a resin material such as polyimide. The nozzle plate 50 is disposed on one side of the manifold 40 so as to cover the pressure chamber 31. The nozzles 51 penetrate in the thickness direction of the nozzle plate 50. The nozzles 51 are arranged in a row or rows along the X direction to form a nozzle array. Each nozzle 51 is provided at a position corresponding to one of the pressure chambers 31.

The frame 60 is disposed on one side of the diaphragm 30. The frame 60 forms the common chamber 32 with the diaphragm 30. The common chamber 32 is formed inside the frame 60 and connects via the guide flow path 34 to the pressure chamber(s) 31 through the opening 33 provided in the diaphragm 30.

In the inkjet head 1, when a drive voltage is applied to the electrodes 221 and 222 by the drive IC, a piezoelectric element 20 vibrates in the stacking direction (Z direction), that is, in the thickness direction of each piezoelectric member 21. That is, the piezoelectric element 20 vibrates vertically. The diaphragm 30 vibrates due to the vertical vibration of the piezoelectric element 20, and the pressure chamber 31 is thus deformed by the vibration in the Z direction. Then, as the internal volume of the pressure chamber 31 changes, ink is drawn from the common chamber 32, and then ejected from the nozzle 51.

In the process of manufacturing the inkjet head 1, the piezoelectric element 20 is generally first prepared. Specifically, a raw material powder is prepared, a binder, a plasticizer, or the like is mixed, kneaded, and molded into a sheet to obtain a sheet-shaped piezoelectric material. The internal electrode is then printed on the sheet-shaped piezoelectric material to form the piezoelectric members 21. Then, a plurality of piezoelectric members 21 on which the internal electrodes are formed are stacked and then cut into pieces of a predetermined shape. Subsequently, the piezoelectric element 20 is formed through firing treatment (heat treatment), individualization by dicing, printing/formation of the external electrodes, and polarization treatment. The obtained piezoelectric elements 20 are then arranged at a predetermined pitch and attached to the base 10 with an adhesive or the like. The manifold 40 and the frame 60 are then joined, and the nozzles 51 are positioned so as to face respective pressure chambers 31 when the nozzle plate 50 is bonded to complete the inkjet head 1.

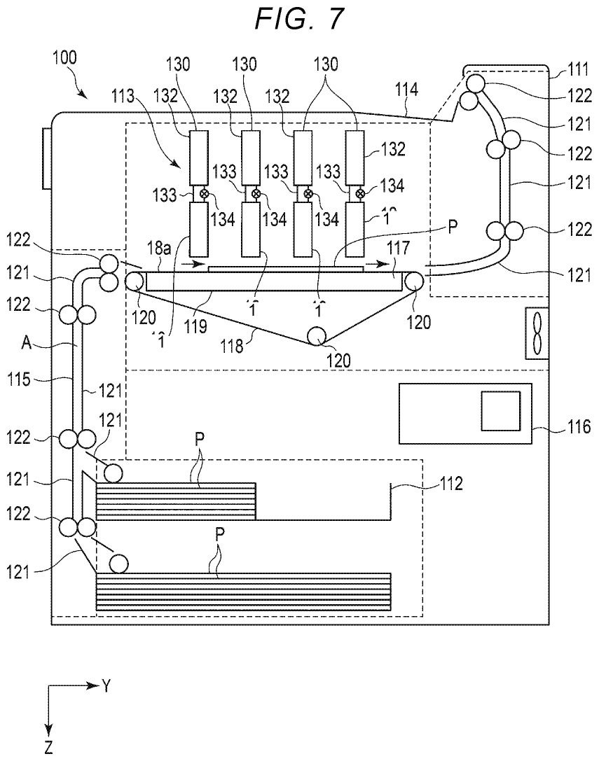

An example of an inkjet recording device 100 including an inkjet head 1 will be described with reference to FIG. 7. The inkjet recording device 100 includes a housing 111, a sheet supply unit 112, an image forming unit 113, a sheet discharge unit 114, a conveyance device 115, and a control unit 116.

The inkjet recording device 100 is one type of a liquid ejection device that performs image forming processing on a paper P by ejecting a liquid (such as ink) while the paper P is conveyed past the inkjet head 1, along a predetermined conveyance path A from the sheet supply unit 112 to the sheet discharge unit 114 through the image forming unit 113.

The housing 111 forms the outer shell of the inkjet recording device 100. A discharge port for discharging the paper P to the outside is provided on the housing 111.

The sheet supply unit 112 has a plurality of paper feed cassettes, and can be configured for a plurality of sheets of paper P of various sizes.

The sheet discharge unit 114 includes a discharge tray configured to hold the paper P discharged from the discharge port.

The image forming unit 113 includes a support unit 117 that supports the paper P, and a plurality of head units 130 that are disposed so as to face the support unit 117.

The support unit 117 includes a conveyance belt 118 provided in a loop shape, a support plate 119 for supporting the conveyance belt 118 from the back side, and a plurality of belt rollers 120 provided on the back side of the conveyance belt 118.

For image formation, the support unit 117 conveys the paper P to the downstream side on a holding surface (which is the upper surface of the conveyance belt 118) by feeding the conveyance belt 118 at a predetermined timing by the rotation of the belt rollers 120.

A head unit 130 includes an inkjet head 1 (in this example a head unit 130 is provided for each of four different colors, e.g., CYMK colors). For each inkjet head 1, an ink tank 132, a connection flow path 133 for connecting the inkjet head 1 and the ink tank 132, and a supply pump 134 are provided.

In the present embodiment, inkjet heads 1 for four different colors (cyan, magenta, yellow, and black), and ink tanks 132 containing ink of each of these colors are provided. Each ink tank 132 is connected to the respective inkjet head 1 by a connection flow path 133.

A negative pressure control device such as a pump is connected to the ink tank 132. Then, the ink supplied to each ejection nozzle 51 of the inkjet head 1 forms into a meniscus of a predetermined shape by controlling pressure inside of the ink tank 132 to be a negative pressure according to the hydraulic head value of the inkjet head 1 and the ink tank 132.

The supply pump 134 is a liquid feeding pump composed of, for example, a piezoelectric pump. The supply pump 134 is provided in the supply flow path. The supply pump 134 is connected to the drive circuit of the control unit 116 by wiring, and is configured to be controllable by the control of a central processing unit (CPU). The supply pump 134 supplies the liquid to the inkjet head 1.

The conveyance device 115 conveys the paper P along the conveyance path A from the sheet supply unit 112 to the sheet discharge unit 114 through the image forming unit 113. The conveyance device 115 includes a plurality of guide plate pairs 121 disposed along the conveyance path A, and a plurality of conveyance rollers 122.

Each of the plurality of guide plate pairs 121 includes a pair of plate members that are disposed so as to face each other with the paper P to be conveyed interposed therebetween, and guides the paper P along the conveyance path A.

The conveyance roller 122 is driven by the control of the control unit 116 and rotates to feed the paper P to the downstream side along the conveyance path A. Sensors for detecting the paper conveyance status are disposed in various places along the conveyance path A.

The control unit 116 includes a control circuit such as a CPU that is a controller, a read only memory (ROM) that stores various programs, a random access memory (RAM) that temporarily stores various variable data and image data, and an interface unit that inputs data from the outside and outputs data to the outside.

In the inkjet recording device 100, when a print instruction is received by user operation on an operation input unit, the control unit 116 drives the inkjet head 1 by driving the conveyance device 115 to convey the paper P and outputting a print signal to the head unit 130 at a predetermined timing. As an ejection operation, the inkjet head 1 sends a drive signal to the drive IC corresponding to an image signal for the image data, applies a drive voltage to the electrode 22 via wiring to selectively drive the piezoelectric elements 20 to vibrate vertically in the stacking direction, and changes the volume of the pressure chamber 31 to eject ink from the nozzle 51 and form an image on the paper P held on the conveyance belt 118. Further, as a liquid ejection operation, the control unit 116 supplies ink from the ink tank 132 to the common chamber 32 of the inkjet head 1 by driving the supply pump 134.

With the inkjet head 1 and the inkjet recording device 100, it is possible to utilize the inkjet head 1 made of a lead-free piezoelectric material. That is, by providing a piezoelectric element in which a plurality of layers of lead-free piezoelectric material are stacked and then driving the piezoelectric element to vibrate in the layer stacking direction, it is still possible to obtain a required displacement for ink ejection in a compact head size. The displacement amount in the inkjet head 1 can be increased by increasing the number of stacked layers, and it is thus relatively easy to obtain a desired displacement in combination with an appropriate operating voltage. Further, because the thickness is still small in the layer direction, the influence on device size is small even when the number of layers is increased, and because the influence on the actuator pitch associated with increased number of layers is small, it is still possible to realize a desired displacement amount in an appropriate size with a lead-free piezoelectric material having a small piezoelectric constant.

Since there are fewer process restrictions and operating characteristics are close to those of PZT a lead-free piezoelectric material comprising potassium sodium niobate as the main component can be readily adopted as a piezoelectric material into existing PZT-stacked vertically vibrating inkjet head designs.

The inkjet head 1 can be realized without substantially increasing the thickness or drive voltage if the thickness of each layer is 10 μm to 40 μm, the number of stacked layers is 50 or less, and/or the product of thickness and the number of layers is less than 1000. Therefore, it is not necessary to change the drive IC, and the capacitance and power consumption can be suppressed.

As a comparative example, in the case of a bending type in which a thin plate-shaped piezoelectric material is expanded and contracted in the horizontal direction, and a diaphragm deformed to pressurize ink, if the piezoelectric constant (d31) is small, it is necessary to increase the voltage or increase the width of the actuator along the arrangement direction of the nozzles 51 themselves in order to obtain the amount of deformation. Further, even in the case of a shear mode sidewall type inkjet head design in which the side wall of an ink chamber is deformed by the shear mode (d15) of a piezoelectric material to directly pressurize ink, when the piezoelectric constant (d15) is small, it is necessary to increase the voltage or increase the size of the actuator in the depth direction in order to obtain the same amount of deformation. Further, in a shear mode roof type inkjet head design in which the top plate of an ink chamber is deformed to directly pressurize ink by using the shear mode (d15) of a piezoelectric material, if the piezoelectric constant (d15) is small, it is necessary to increase the voltage or increase the size of the actuator in the width direction in order to obtain the same amount of deformation. Therefore, in the configurations of these comparative examples, it is generally necessary to increase the voltage in order to obtain the desired displacement amount. Thus, the amount of the piezoelectric material used increases, and the actuator pitch also increases. As the actuator pitch increases, the entire head becomes larger. In addition, in a piston type inkjet head design that presses a diaphragm by the direct expansion and contraction of a piezoelectric material to pressurize the ink, if the horizontal vibration (d31) of just a single piezoelectric material (e.g., one layer only) is used, then the required material becomes larger and the entire head becomes larger together with a cost increase for additional material. In the case of the vertical vibration of a single piezoelectric material (e.g., one layer only), if the size of the actuator is increased in the vertical direction, the voltage also increases proportionally, which makes it difficult to put such a design into practical use. In the case of horizontal vibration of a single piezoelectric material, it is necessary to increase the size of the actuator in the width direction in order to increase the displacement.

In contrast to these comparative examples, the inkjet head 1 according to the present embodiment can be more compact and it is possible to obtain a large displacement by stacking layers of the lead-free piezoelectric material and then utilizing vertical vibration in the stacking direction.

The present disclosure is not limited to the above-described embodiments and the various components can be modified in various aspects which does not deviate from the gist of the described embodiments.

For example, the specific configuration of a piezoelectric element 20, the shape of the flow path, the configuration and positional relationship of various components including the manifold 40, the nozzle plate 50, and the frame 60 are not limited to the above examples, and can be changed as appropriate. Further, the arrangement of the nozzles 51 and the pressure chambers 31 is not limited to the above. For example, the nozzles 51 may be arranged in two or more rows. Further, a dummy chamber may be formed between adjacent pressure chambers 31. Further, an example in which the piezoelectric element 20 has dummy layers 24 at both ends in the stacking direction has been illustrated, but the exemplary embodiment is not limited thereto, and the dummy layer 24 may instead be provided only on one side of the piezoelectric element 20, or the piezoelectric element 20 may not have any dummy layers 24.

The liquid to be ejected from inkjet head 1 is not limited to the ink for printing, and for example, a device that ejects a liquid containing conductive particles for forming a wiring pattern of a printed circuit board or the like may be used.

The inkjet head 1 can be used for 3D printers, industrial manufacturing machines, and medical applications, and can be reduced in the size, weight, and cost.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A liquid ejection head, comprising:
an actuator with plate-shaped piezoelectric members stacked one on the other in a stacking direction, the plate-shaped piezoelectric members each comprising a lead-free piezoelectric material; and
a diaphragm adjacent to the actuator, the diaphragm being configured to vibrate in its thickness direction based on vibrations of the plate-shaped piezoelectric members in the stacking direction.

2. The liquid ejection head according to claim 1, wherein the lead-free piezoelectric material comprises potassium sodium niobate.

3. The liquid ejection head according to claim 1, wherein
the number of stacked plate-shaped piezoelectric members is 50 or less, and
each plate-shaped piezoelectric member is between 10 μm to 40 μm in thickness in the stacking direction.

4. The liquid ejection head according to claim 3, wherein the number of stacked plate-shaped piezoelectric members multiplied by individual thickness of the plate-shaped piezoelectric members is less than 1000 μm.

5. The liquid ejection head according to claim 1, wherein
the diaphragm is a portion of a pressure chamber which changes volume due to vibration of the actuator in the stacking direction, and
the pressure chamber has a nozzle in fluid communication therewith.

6. The liquid ejection head according to claim 1, further comprising:
a nozzle plate including a nozzle; and
a manifold including a pressure chamber adjacent to the nozzle, wherein
the diaphragm is on the manifold and covers the pressure chamber, and
the diaphragm is between the pressure chamber and plate-shaped piezoelectric members in the stacking direction.

7. The liquid ejection head according to claim 6, further comprising:
a plurality of internal electrodes respectively connected to each of plate-shaped piezoelectric members.

8. The liquid ejection head according to claim 6, wherein the lead-free piezoelectric material comprises potassium sodium niobate.

9. The liquid ejection head according to claim 6, further comprising:
a frame member including a common pressure chamber, wherein
the diaphragm is between the frame member and the manifold,
the diaphragm includes an opening connected to the common pressure chamber, and
the manifold includes a flow path from the opening to the pressure chamber in the manifold.

10. The liquid ejection head according to claim 9, wherein the frame member is adjacent to the actuator in a direction perpendicular to the stacking direction.

11. The liquid ejection head according to claim 10, wherein the lead-free piezoelectric material comprises potassium sodium niobate.

12. The liquid ejection head according to claim 11, wherein
the number of stacked plate-shaped piezoelectric members is 50 or less, and
each plate-shaped piezoelectric member is between 10 μm to 40 μm in thickness in the stacking direction.

13. An inkjet print head, comprising:
a nozzle plate including a plurality of nozzles therein;
a manifold on the nozzle plate and forming a plurality of pressure chambers corresponding in position to each of the plurality of nozzles;
a diaphragm on the manifold above the plurality of pressure chambers in a first direction, the diaphragm being configured to vibrate in the first direction and change the volume of each of the plurality of pressure chambers; and
a plurality of piezoelectric actuators on the diaphragm, each piezoelectric actuator being respectively above one of the plurality of pressure chambers and configured to vibrate back and forth along the first direction, each piezoelectric actuator comprising:
a plurality of plate-shaped piezoelectric members stacked in the first direction, the plate-shaped piezoelectric members each comprising a lead-free piezoelectric material, and
a plurality of internal electrode pairs, each plate-shaped piezoelectric member being respectively connected to one of the plurality of internal electrode pairs.

14. The inkjet print head according to claim 13, wherein the lead-free piezoelectric material comprises potassium sodium niobate.

15. The inkjet print head according to claim 13, wherein
the number of plate-shaped piezoelectric members in each of the plurality of piezoelectric actuators is 50 or less, and
each plate-shaped piezoelectric member is between 10 μm to 40 μm in thickness in the first direction.

16. A liquid ejection device, comprising:
a liquid ejection head; and
a support member configured to support a print medium at a position facing the liquid ejection head, wherein
the liquid ejection head includes:
an actuator with plate-shaped piezoelectric members stacked one on the other in a stacking direction, the plate-shaped piezoelectric members each comprising a lead-free piezoelectric material, and
a diaphragm adjacent to the actuator, the diaphragm being configured to vibrate in its thickness direction based on vibrations of the plate-shaped piezoelectric members in the stacking direction.

17. The liquid ejection device according to claim 16, wherein the lead-free piezoelectric material comprises potassium sodium niobate.

18. The liquid ejection device according to claim 16, wherein
the number of stacked plate-shaped piezoelectric members is 50 or less, and
each plate-shaped piezoelectric member is between 10 μm to 40 μm in thickness in the stacking direction.

19. The liquid ejection device according to claim 16, wherein
the diaphragm is a portion of a pressure chamber which changes volume due to vibration of the actuator in the stacking direction, and
the pressure chamber has a nozzle in fluid communication therewith.

20. The liquid ejection device according to claim 16, wherein the liquid ejection head further includes:
a nozzle plate including a nozzle; and
a manifold including a pressure chamber adjacent to the nozzle, wherein
the diaphragm is on the manifold and covers the pressure chamber, and
the diaphragm is between the pressure chamber and plate-shaped piezoelectric members in the stacking direction.
